(19) United States
(12) Patent Application Publication
(10) Pub. No.: US 2011/0006893 A1
(43) Pub. Date: Jan. 13, 2011

(54) NOTIFICATION SYSTEM UTILIZING SELF-ENERGIZING SWITCHES

(76) Inventors: John Gerard Finch, Livonia, MI (US); Thomas Aian Barnett, Ypsilanti, MI (US); Jeffrey Iott, Monroe, MI (US)

Correspondence Address: Carlson, Gaskey & Olds/Masco Corporation, 400 West Maple Road, Suite 350, Birmingham, MI, 48009, US

(21) Appl. No.: 12/667,934

(22) PCT Filed: Jul. 25, 2008
(86) PCT No.: PCT/US08/71120

§ 371 Date: Jan. 6, 2010

Related U.S. Application Data
(60) Provisional application No. 60/954,007, filed on Aug. 5, 2007.

(51) Int. Cl. G08B 1/08; G08B 21/00

(52) U.S. Cl. 340/539.1; 340/540

(57) ABSTRACT

An example notification system includes a power supply and a notification device in selective electrical communication with the power supply. The notification device provides a notification to a building service location when the notification device is electrically connected with the power supply. A receiver is electrically connected between the power supply and the notification device. The receiver is operative to selectively electrically connect the notification device with the power supply in response to a wireless communication. A switch includes a wireless transmitter portion powered by a self-energizing portion. The wireless transmitter portion communicates the wireless communication to the receiver in response to an actuation of the switch.

### CROSS-REFERENCE TO RELATED APPLICATIONS

The application claims priority to U.S. Provisional Application Ser. No. 60/954,007 filed on 5 Aug. 2007, which is incorporated herein by reference.

### BACKGROUND

This application relates to notification systems, and more particularly to notification systems that utilize self-energizing switches.

Switches that transmit wireless communications are known. For example, some switches transmit wireless communications to garage door openers. Many switches utilize a replaceable internal power source, such as a battery, to power the wireless communication transmissions. Servicing these internal power sources can be inconvenient and costly. For example, accessing a battery within a wall-mounted light switch is often difficult and time-consuming. Rather than replaceable internal power sources, some switches harvest energy to power the wireless communication transmissions.

Some buildings utilize notification systems to alert building service locations to activities within various rooms of the buildings. Prior notification systems include wired and battery based switches, both of which are often expensive and inflexible.

### SUMMARY

An example notification system includes a power supply and a notification device in selective electrical communication with the power supply. The notification device provides a notification to a building service location when the notification device is electrically connected with the power supply. A receiver is electrically connected between the power supply and the notification device. The receiver is operative to selectively electrically connect the notification device with the power supply in response to a wireless communication. A switch includes a wireless transmitter portion powered by a self-energizing portion. The wireless transmitter portion communicates the wireless communication to the receiver in response to an actuation of the switch.

In another example, a notification system includes a power supply and a notification device in selective electrical communication with the power supply. The notification device is operative to initiate a notification within a first room when electrically connected with the power supply. A receiver is electrically connected between the power supply and the notification device. The receiver is operative to selectively electrically connect the notification device with the power supply to initiate the notification. A switch is located within a second room and has a wireless transmitter portion powered by a self-energizing portion. The wireless transmitter portion communicates the wireless communication to the receiver in response to power from the self-energizing portion.

An example notification method includes communicating a wireless communication using power provided by a self-energizing portion of a switch and providing a notification to a building service location in response to the communicated wireless communication.

These and other features of the present invention can be best understood from the following specification and drawings, the following of which is a brief description.

### BRIEF DESCRIPTION OF THE DRAWINGS

FIG. 1 schematically illustrates an example notification system.

FIG. 2 shows the FIG. 1 notification system implemented within an example building.

FIG. 3 shows the FIG. 1 notification system implemented within another example building.

### DETAILED DESCRIPTION

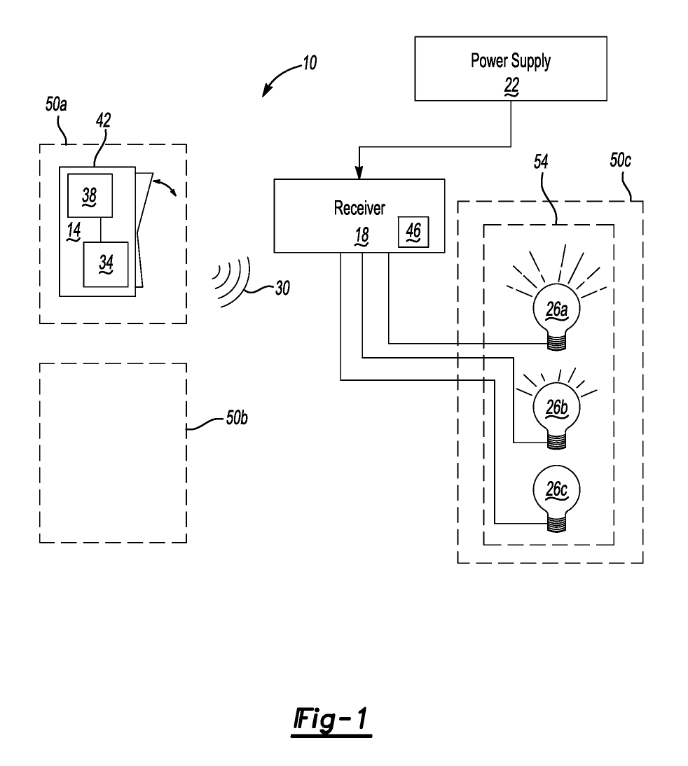

Referring to FIG. 1, an example notification system 10 includes a switch 14 in wireless communication with a receiver 18. A power supply 22 is operative to power to a first notification light 26a, a second notification light 26b, and a third notification light 26c, which are each example notification devices. The receiver 18 selectively couples the power supply 22 to one or more of the notification lights 26a-26c in response to a wireless communication 30 from the switch 14.

In this example, the switch 14 is self-energizing and includes a wireless transmitter portion 34 and a self-energizing portion 38. The self-energizing portion 38 provides power to the wireless transmitter portion 34, which transmits the wireless communication 30. One example switch 14 suitable for transmitting the wireless communication 30 is available from EnOcean under Product No. PTM250.

The example switch 14 is a rocker type switch. That is, the switch 14 is actuated by rocking a portion of the switch 14 within a switch housing 42. Other examples of the switch 14 incorporate motion sensors that are actuated by the presence of a user's hand. Other examples include push button type switches.

In one example, the actuation of portions of the switch 14 energizes the self-energizing portion 38 of the switch 14. In other examples, the self-energizing portion 38 energizes through photovoltaic cells, piezoelectric devices, etc. The example switch 14 thus does not rely on an internal power supply to power the wireless communication 30, but instead harvests an external source of energy to power the wireless communication 30.

Although the receiver 18 is shown as a multi-channel receiver, it should be understood that the receiver 18 could also be a single channel receiver. Other examples include the receiver 18 coupled to more or fewer of the notification lights 26a-26c. Although described as notification lights 26a-26c, other example notification systems 10 utilize other forms of notification, such as music or updating a computer display.

Other examples of the notification system 10 also utilize more than one of the receiver 18. Further, although the location of the receiver 18 is fixed in this example, other example receivers are portable. For example, other examples of the receiver 18 include a USB portion and are operative to receive the wireless communication 30 once the USB portion is linked to a computer (not shown). Such examples facilitate moving the receiver 18 to receive the wireless communication 30 in a multiple of areas. One example receiver 18 suitable for use with the notification system 10 is available from EnOcean under Product No. RCM130C. This example of the receiver is radio-based and configured for incorporation into the notification system 10.

The example receiver 18 includes a programmable controller 46 that controls the illumination levels of the notification lights 26a-26c by controlling the coupling between the power supply 22 and each of the notification lights 26a-26c, the power level supplied to the notification lights 26a-26c from the power supply 22, or both. Illuminating one of the notification lights 26a-26c provides a notification. A person skilled in the art having the benefit of this disclosure would be able to develop a controller suitable for providing the notification using the notification lights 26a-26c. Some examples of the programmable controller 46 include a microprocessor, a laptop computer, etc.

In this example, the switch 14 is located within a room 50a and is operative to communicate the wireless communication to a building service location 54 located within another room 50c. The example switch 14 does not rely on a wired or battery-based power source, which facilitates moving the switch 14 between the room 50a and another room 50b and maintaining wireless transmission capability in both.

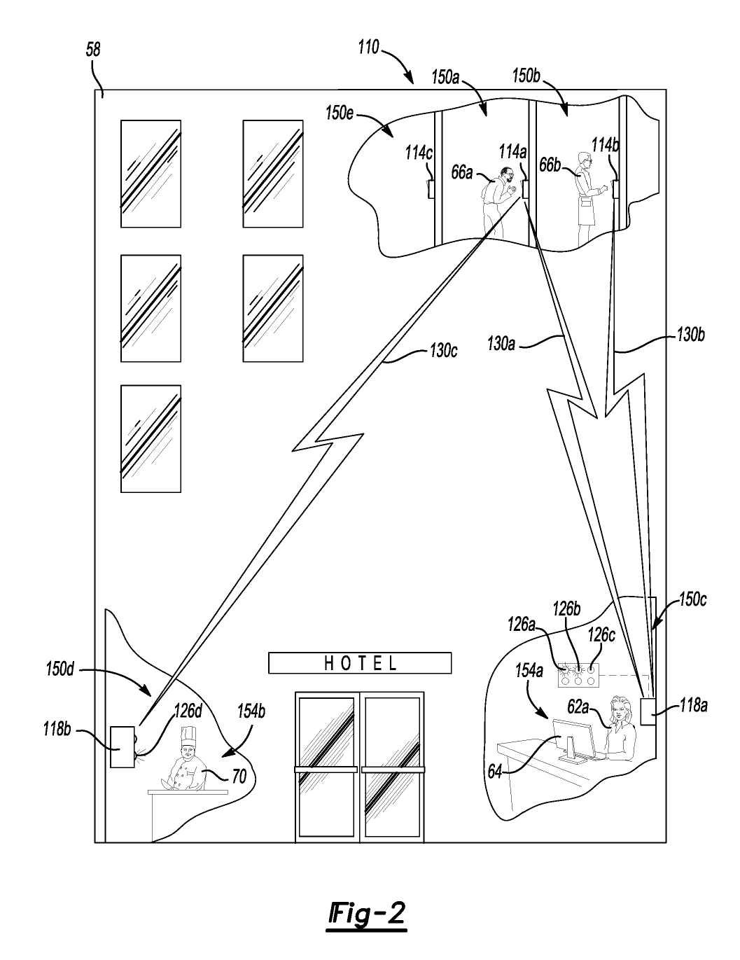

Referring now to FIG. 2 with continuing reference to FIG. 1, one example application for the basic notification system 10 is a notification system 110, which is implemented within a building 58. In this disclosure, like reference numerals designate like elements where appropriate, and reference numerals with the addition of 100 or multiples thereof designate modified elements. The modified elements incorporate the same basic features and benefits of the corresponding modified elements, except where stated otherwise.

In this example, the building 58 is a multi-story hotel having multiple rooms 150a-150e. Some of the rooms 150a-150d include a building service location 154a, 154b. In this example, the service location 154a is a lobby or reception area, and the service location 154b is a kitchen. As known, the building service locations 154a, 154b provide services to a multiple of the rooms 150a-150e within the building 58. Many types of buildings (e.g., apartments, dormitories, libraries, etc.) include the building service locations 154a, 154b. Other example building service locations include concierge stations, valet parking stations, luggage currier stations, etc.

Although described as a single building in this example, this disclosure also applies to groups of related buildings serviced by the building service locations 154a, 154b. For example, a development of detached condominiums (not shown) may be serviced by the building service locations 154a, 154b. A building maintenance department is one type of building service location 154a, 154b suitable for such a use.

The notification system 110 includes switches 114a, 114b each located within a respective one of the rooms 150a-150e. The switch 114a communicates a wireless communication 130a to a receiver 118a when the switch 114a is actuated. The switch 114b communicates a wireless communication 130b to the receiver 118a when the switch 114b is actuated. In this example, the receiver 118a is located proximate the building service location 154a. In another example, a second receiver mounts within one of the room 150a in electrical communication with the switch 114a. The second receiver includes a transceiver for transmitting the wireless communication 130a to the receiver 118a when the switch 114a is actuated.

Upon receipt of the wireless communications 130a, 130b, the receiver 118a selectively couples a light 126a, 126b to the power supply 22. The light 126a, 126b that is illuminated corresponds to the received one of the wireless communications 130a, 130b. A light 126c corresponds to the room 150e having a switch 114c that has not been actuated and thus is not communicating wirelessly with the receiver 118a. Actuating the switch 114a in the room 150a causes the light 126a to illuminate and actuating the switch 114b in the room 150b causes the light 126b to illuminate. The lights 126a, 126b are labeled to notify an attendant 62a at the service location 154a the particular room 150a, 150b in which the switch 114a, 114b was activated. The attendant 120 can then appropriately respond to a guest 66a, 66b within the room 150a or the room 150b. In another example, the receiver 118a initiates a display on a computer monitor 64 to indicate, for example, that the guest 66a in room 150a needs assistance.

In one example, the guest 66a actuates the switch 114a to request a towel delivered to their room. Other examples include actuating the switch 114a to indicate that the guest 66a is checking out of the room 150a. In still other examples, more than one of the switch 114a is used within the room 150a to each indicate a particular request of the guest 66a.

The switch 114a is also capable of sending wirelessly communicating with other areas of the building 58 through the wireless communication 130c. In one example, the guest 66a actuates the switch 114a in a first manner to send the wireless communication 130a and actuates the switch 114a in a second manner to send the wireless communication 130c. For example, the guest 66a actuates the switch 114a once to send the wireless communication 130a and actuates the switch 114a twice to send the wireless communication 130c. In so doing, the switch 114a is operative to send the wireless communication 130a and the wireless communication 130, which enables the switch 114a to communicate with the both the building service location 154a and the building service location 154d.

A second receiver 118b within the building 58 is operative to receive the second wireless communication 130c. The second receiver 118b, in this example, is located proximate a kitchen, another type of building service location 154b. In this example, receipt of the second wireless communication 130b initiates a light 126d, which a kitchen attendant 70 recognizes as a signal to provide room service to the guest 66a in the room 150a.

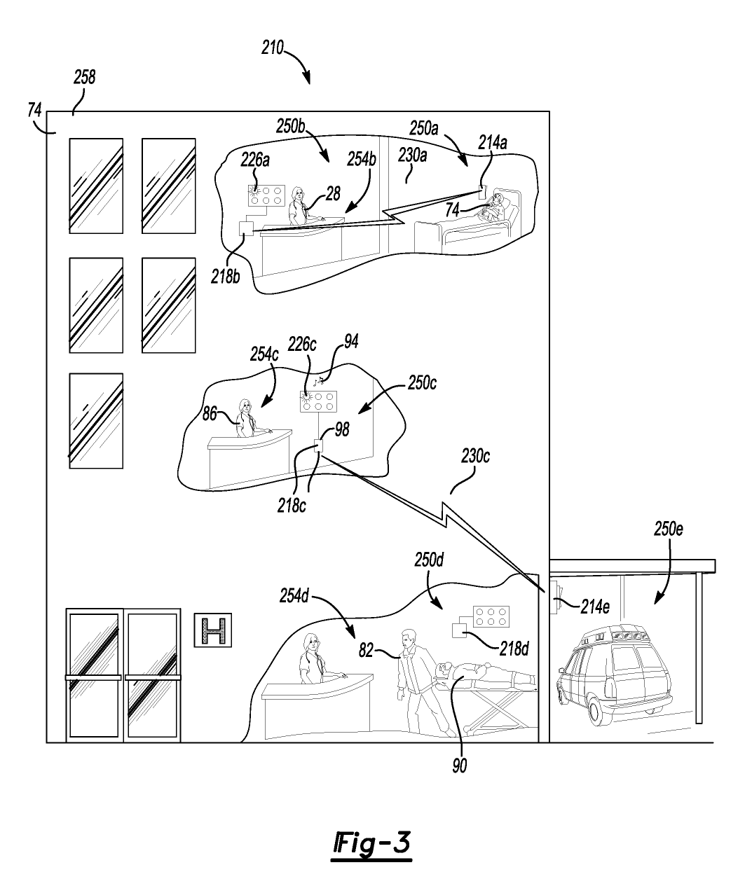

Referring now to FIG. 3 with continuing reference to FIG. 1, another example building 258 is a hospital that includes multiple defined areas or rooms 250a-250e. The rooms 250b-250d include a building service location 254b-254d, which each include a receiver 218b-218d for receiving wireless communications 230a, 230e from the plurality of switches 214a, 214e within a respective one of the rooms 250a-250e.

In one example, a patient 74 within the room 250a actuates the switch 214a to notify the building service location 254b, which is a nurse station in this example. The patient 74 notifies a nurse 78 or other medical professional near the building service location 254b of a condition within the room 250a, such as a spill or that the patient 74 needs assistance.

In another example, a healthcare worker 82 activates the switch 214e to illuminate a light 226c and play a musical tone 94, which are both types of notifications that notify a surgical assistant 86 of a patient 90 requiring immediate surgery that has entered the building 258. The surgical assistant 86 and the receiver 218c are located near a surgical station, another type of building service location 254c.

In one example, the receiver 218c is received within a wall cavity 98, which was adapted to receive a wall outlet. Such a design facilitates installation of the receiver 218c within the building 258 using existing and common wall outlets.

Features of this disclosure include utilizing self-energizing switches to communicate between multiple rooms and a building service location. Another feature of this disclosure is the ability of the wireless switch and a receiver to move within the building while maintaining wireless communication capability.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A notification system, comprising:
a power supply;
a notification device in selective electrical communication with the power supply, the notification device operative to provide a notification to a building service location when electrically connected with the power supply;
a receiver electrically connected between the power supply and the notification device, the receiver operative to selectively electrically connect the notification device with the power supply in response to a wireless communication; and
a switch having a wireless transmitter portion powered by a self-energizing portion, wherein the wireless transmitter portion communicates the wireless communication to the receiver in response to an actuation of the switch.

2. The notification system of claim 1, wherein the notification represents a condition within a room separate from the building service location.

3. The notification system of claim 1, wherein a hospital building includes the building service location.

4. The notification system of claim 3, wherein the switch is located in a patient room of the hospital building.

5. The notification system of claim 1, wherein a hotel includes the building service location.

6. The notification system of claim 5, wherein the switch is located in a guest room of the hotel.

7. The notification system of claim 1, wherein the notification device is a light.

8. The notification system of claim 1, wherein the notification device is operative to play an audible notification.

9. The notification system of claim 1, wherein the building service location is at least one of a station within a hospital or a lobby within a hotel.

10. A notification system comprising:
a power supply;
a notification device in selective electrical communication with the power supply, the notification device operative to initiate a notification within a first room when electrically connected with the power supply;
a receiver electrically connected between the power supply and the notification device, the receiver being operable to selectively electrically connect the notification device with the power supply to initiate the notification; and
a switch located within a second room and having a wireless transmitter portion powered by a self-energizing portion, wherein the wireless transmitter portion communicates the wireless communication to the receiver in response to power from the self-energizing portion.

11. The notification system of claim 10, wherein the first room comprises a building service location.

12. The notification system of claim 10, wherein the notification comprises a display on a computer monitor.

13. The notification system of claim 10, wherein the notification comprises at least one audible tone.

14. The notification system of claim 10, wherein the receiver is located within the first room.

15. The notification system of claim 10, including a controller that is programmable to associate an actuation of the switch with a notification device.

16. The notification system of claim 15, wherein the receiver comprises the controller.

17. A notification method comprising:
communicating a wireless communication using power provided by a self-energizing portion of a switch; and
providing a notification to a building service location in response to the communicated wireless communication.

18. The notification method of claim 17, including actuating a switch to power the self-energizing portion of the switch.

19. The notification method of claim 17, including actuating the switch once to communicate the wireless communication and actuating the switch twice to communicate a different wireless communication.

20. The notification method of claim 17, including actuating the switch in a first manner to communicate the wireless communication and actuating the switch in a second manner to communicate a different wireless communication.
